(19) United States
(12) Patent Application Publication
(10) Pub. No.: US 2014/0182652 A1
(43) Pub. Date: Jul. 3, 2014

(54) ROOF PANEL HAVING DYE-SENSITIZED SOLAR CELL

(71) Applicant: Hyundai Motor Corporation, Seoul (KR)

(72) Inventors: Mi Yeon Song, Seoul (KR); In Woo Song, Yongin (KR); Sang Hak Kim, Seoul (KR); Won Jung Kim, Seoul (KR); Yong Jun Jang, Seongnam (KR); Ji Yong Lee, Suwon (KR); Yong Gu Kim, Seoul (KR)

(21) Appl. No.: 13/938,551

(22) Filed: Jul. 10, 2013

(30) Foreign Application Priority Data
Dec. 28, 2012 (KR) 10-2012-0155798

(51) Int. Cl. H01G 9/20

(52) U.S. Cl. CPC H01G 9/2068
USPC 136/244

(57) ABSTRACT

A roof panel is provided that includes a dye-sensitized solar cell. In particular, the roof panel includes a plurality of dye-sensitized solar cell unit modules having a matrix array. Electrodes of the dye-sensitized solar cell unit modules are disposed and joined to each other across a wire connection structure. Here, the plurality of dye-sensitized solar cell unit modules are connected in series and parallel to each other.

### CROSS-REFERENCE TO RELATED APPLICATION

This application claims under 35 U.S.C. §119(a) the benefit of Korean Patent Application No. 10-2012-0155798 filed Dec. 28, 2012, the entire contents of which are incorporated herein by reference.

### BACKGROUND

(a) Technical Field

The present invention relates to a roof panel having a dye-sensitized solar cell. More particularly, it relates to a roof panel having a dye-sensitized solar cell, which can improve the power generation efficiency of a dye-sensitized solar cell module by implementing the roof panel for vehicles with a plurality of dye-sensitized solar cell modules that are joined together and reducing a resistance at each joining part.

(b) Background Art

A dye-sensitized solar cell refers to a cell in which a TiO₂ electrode adsorbed with Ru-based dye capable of absorbing light and a counter electrode coated with Pt are joined over a transparent electrode and I⁻/I₃⁻ based electrolyte is applied therebetween. Since dye-sensitized solar cells can be manufactured using a transparent electrode at low cost, and implemented in various designs of solar cells, many studies have been focused thereon. Amid many continuous attempts to apply the dye-sensitized solar cells to various application fields, many studies are being actively conducted to apply dye-sensitized solar cells to roofs or windows of buildings for Building Integrated Photovoltaics (BIPV). Accordingly, attempts to replace silicon solar cells currently applied to the roof of a vehicle with dye-sensitized solar cells are also being made.

Besides, dye-sensitized solar cells are expected to be applicable to various products, and the most promising fields are electronic goods (e.g., cellular phones, MP3 players, and game consoles) and windows of building.

Particularly, as an application structure of a dye-sensitized solar cell, attempts to apply dye-sensitized solar cell to sunroof panels and panoramic sunroof panels of vehicles are being made, emerging from situations where dye-sensitized solar cells are simply manufactured on glass substrate or flexible dye-sensitized solar cells are only applied to curved parts such as bags or clothes. However, since there is a limitation in weight and thickness upon application to sunroof panels and panoramic sunroof panels of vehicles, further studies about the joining part between dye-sensitized solar cell modules are being conducted.

In a related art, in order to apply dye-sensitized solar cell unit modules to roof panels of vehicles, the dye-sensitized solar cell modules are arranged in series-parallel, and joining parts therebetween are joined via silver paste. However, this may cause low power generation efficiency of the solar cell module when a resistance at the joining parts increases.

When electrodes of dye-sensitized solar cell unit modules are joined by only silver paste, the contact therebetween is not sufficient and thus the resistance increases, reducing the power generation efficiency of the dye-sensitized solar cell unit modules. Accordingly, there is a need for a method that can reduce the resistance of electrode parts when electrodes of dye-sensitized solar cell unit modules are joined to each other.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a roof panel having a dye-sensitized solar cell, which can improve the power generation efficiency of a dye-sensitized solar cell module, by connecting a plurality of dye-sensitized solar cell modules in series/parallel and applying a wire connection structure so as to reduce a resistance within electrode parts where the dye-sensitized solar cell modules are joined together.

In one aspect, the present invention provides a roof panel including a dye-sensitized solar cell, including a plurality of dye-sensitized solar cell unit module having a matrix array, electrodes of which are disposed and joined to each other across a wire connection structure, wherein the plurality of dye-sensitized solar cell unit modules are connected in series/parallel to each other.

In an exemplary embodiment, among the plurality of dye-sensitized solar cell unit modules having the matrix array, dye-sensitized solar cell unit modules in a longitudinal direction may be connected in series lines, and the series lines may be connected in a parallel to connect the plurality of dye-sensitized solar cell unit modules in the series-parallel to each other.

In another exemplary embodiment, two or more series lines selected from the series lines may be connected in parallel by a bypass line.

In still another exemplary embodiment, the wire connection structure may be formed of a wire made of a soft material (soft wire) manufactured using one material selected from a group consisting of copper, gold, silver, aluminum, and alloy thereof.

In yet another exemplary embodiment, the plurality of dye-sensitized solar cell unit modules may include the electrodes coated with conductive paste and a soft wire stacked therebetween to join the electrodes.

In still yet another exemplary embodiment, the plurality of dye-sensitized solar cell unit modules may include a soft wire directly bonded to each of the electrodes.

In a further exemplary embodiment, the wire connection structure may include a soft wire provided in a single straight line, a dual straight line, a zigzag line, a mesh, or a wave line.

In another further exemplary embodiment, the wire connection structure may include a soft wire deformed into a flat shape by a pressurized bonding strength when being disposed and bonded between the electrodes of the dye-sensitized solar cell unit modules.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a cross-sectional view illustrating a roof panel structure of a dye-sensitized solar cell according to an exemplary embodiment of the present invention;

FIG. 2 is a plan view illustrating a matrix array including a plurality of dye-sensitized solar cell unit modules constituting a dye-sensitized solar cell roof panel according to an exemplary embodiment of the present invention;

FIGS. 3A through 3C are views illustrating series/parallel connection of a plurality of dye-sensitized solar cell unit modules constituting a dye-sensitized solar cell roof panel;

FIGS. 4A through 4C are views illustrating a bypass line together with series/parallel connection of a plurality of dye-sensitized solar cell unit modules constituting a dye-sensitized solar cell roof panel;

FIGS. 5A through 5E are views illustrating an exemplary soft wire coupled to an electrode of a plurality of dye-sensitized solar cell unit modules constituting a dye-sensitized solar cell roof panel;

FIG. 6 is a view illustrating a structure of mutually coupling an electrode of a plurality of dye-sensitized solar cell unit modules constituting a dye-sensitized solar cell roof panel with a soft wire;

FIG. 7 is a cross-sectional view illustrating a comparison between dye-sensitized solar cell unit modules joined with a soft wire and dye-sensitized solar cell unit modules joined without a soft wire; and

FIGS. 8A-H are views illustrating a process of manufacturing a dye-sensitized solar cell unit module to manufacture a roof panel according to an exemplary embodiment of the present invention.

Reference numerals set forth in the Drawings includes reference to the following elements as further discussed below:
10: dye-sensitized solar cell unit module
11: electrode
12: module sealing
14: PVB film
16: module protection film
18: tempered glass
20: roof panel
22: series line
24: parallel line
26: bypass line
30: soft wire

It should be understood that the accompanying drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of the invention are discussed infra.

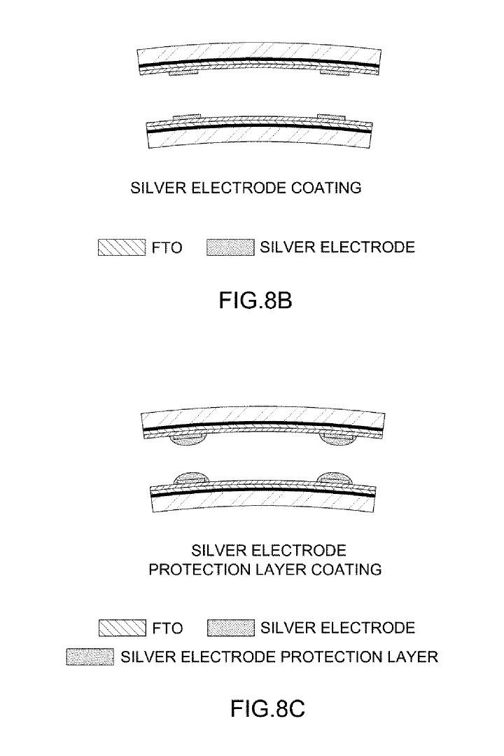

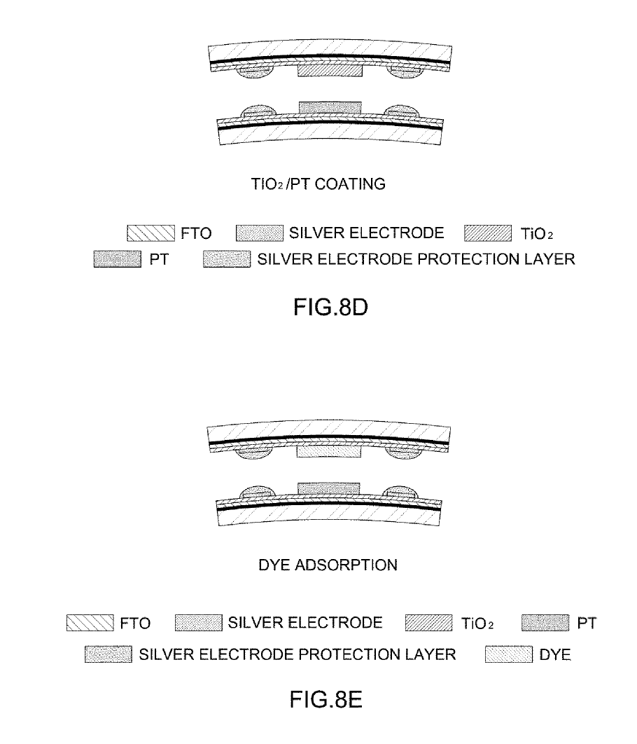

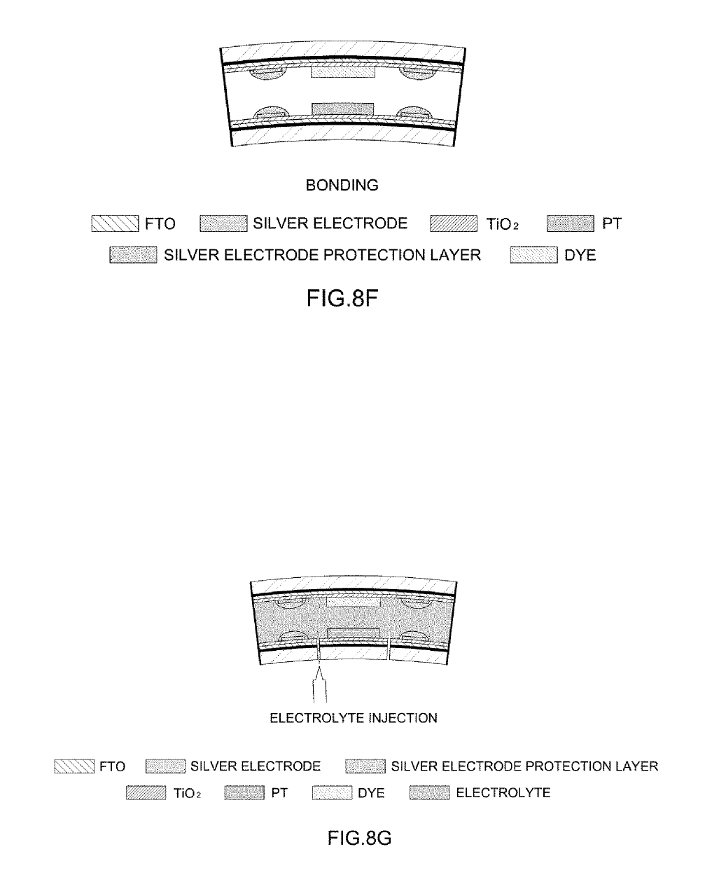

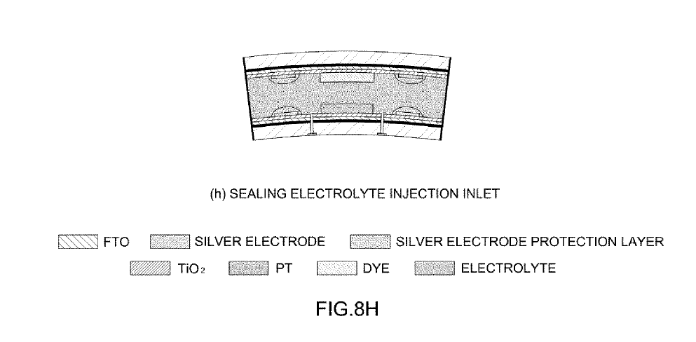

Hereinafter, exemplary embodiments of the present invention will be described in detail with reference to the accompanying drawings. For better understanding of the present invention, a process of manufacturing a dye-sensitized solar cell unit module will be described with reference to FIG. 8.

First, a fluorine tin oxide (FTO) conductive film may be coated on a concave surface of a first curved glass substrate and a convex surface of a second curved glass substrate by, e.g., a Spray Prolysis Deposition (SPD) method, respectively (see FIG. 8A). A flat FTO glass substrate may be also used for the manufacture of the module.

In this case, the conductive film coated on the concave surface of the curved glass substrate may be used as a working electrode, and the conductive film coated on the convex surface of the glass substrate may be used as a counter electrode. Next, a silver electrode serving as a collector may be coated on the working electrode and the counter electrode of the glass substrate (see FIG. 8B), and a silver electrode protection layer may be coated thereon using a glass frit (see FIG. 8C).

TiO₂ may be coated over the conductive film coated on the concave surface of the glass substrate. More specifically, TiO₂ may be coated thereon to form a TiO₂ electrode film having a thickness of about 15 μm and serving as a photoelectrode. On the other hand, a Pt electrode may be coated thereon over the conductive film coated on the convex surface of the glass substrate (see FIG. 8D).

In this case, the curve conductive substrate may be coated with the Pt electrode after an electrolyte injection inlet is formed prior to the Pt treatment. Next, a dye may be adsorbed by the TiO₂ electrode film via a typical process (see FIG. 8E), and then the working electrode on the upper side of the glass substrate and the counter electrode on the lower side of the glass substrate may be joined to each other by sealing via a conductive member (see FIG. 8F).

Electrolytes may be injected into the module through the electrolyte injection inlet formed in the curved substrate of the counter electrode (see FIG. 8G), and then the electrolyte injection inlet may be sealed to complete a dye-sensitized solar cell unit module (see FIG. 8H). When the translucent dye-sensitized solar cell unit modules 10 are partially joined to each other with an adhesive between their sealings 12, a plurality of dye-sensitized solar cell unit modules 10 can be manufactured into a structure in which the dye-sensitized solar cell unit modules 10 are conductively connected to each other. When viewed from the outside, a grid 20 serving as a collector, i.e., the silver electrode serving as the collector may be arranged in one direction.

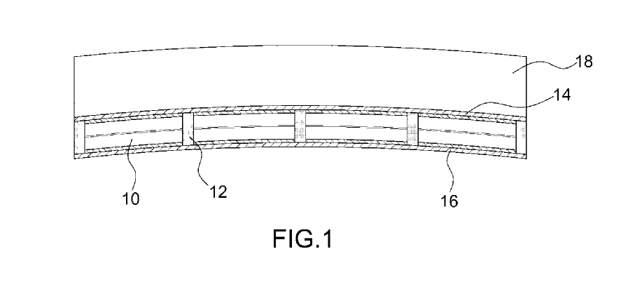

Hereinafter, an exemplary roof panel constituted using the dye-sensitized solar cell unit module manufactured as above will be described with reference to FIG. 1.

As shown in FIG. 1, the dye-sensitized solar cell unit modules 10 may be connected to each other by the module sealing 12 that serves as an electrode. A PVB film 14 may be attached onto the upper surface of the connection structure of the dye-sensitized solar cell unit modules 10, and a module protection film 16 may be attached onto the undersurface of the connection structure. In particular, a tempered glass 18 may be disposed on the PVB film. Additionally, the tempered glass 18 may be formed of the same material as the original roof panel (e.g., panoramic sunroof).

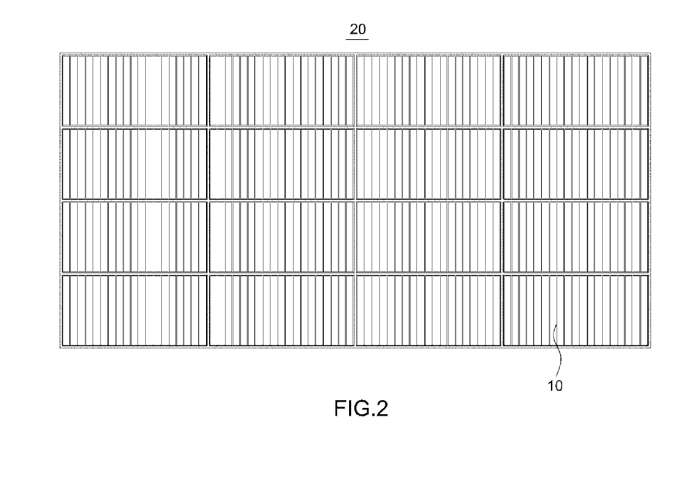

When the dye-sensitized solar cell unit modules 10 are connected to each other by the module sealing 12, i.e., electrode joint, as shown in FIG. 2, the plurality of dye-sensitized solar cell unit modules 10 may form a roof panel 20 in which the dye-sensitized solar cell unit modules 10 form a matrix arrangement.

The present invention is characterized in that when a plurality of dye-sensitized solar cell unit modules are joined to each other to form a roof panel, each electrode of the plurality of dye-sensitized solar cell unit modules are joined across a wire connection structure and the dye-sensitized solar cell unit modules are connected in series/parallel to each other

First, the reason why the dye-sensitized solar cell unit modules are connected in series/parallel to each other to configure the roof panel according to the exemplary embodiments of the present invention is described as follows.

Accordingly, when the dye-sensitized solar cell unit modules are configured in the roof panel, it is desirable that modules having the same performance are connected in the series/parallel structure to obtain a target output current and voltage values.

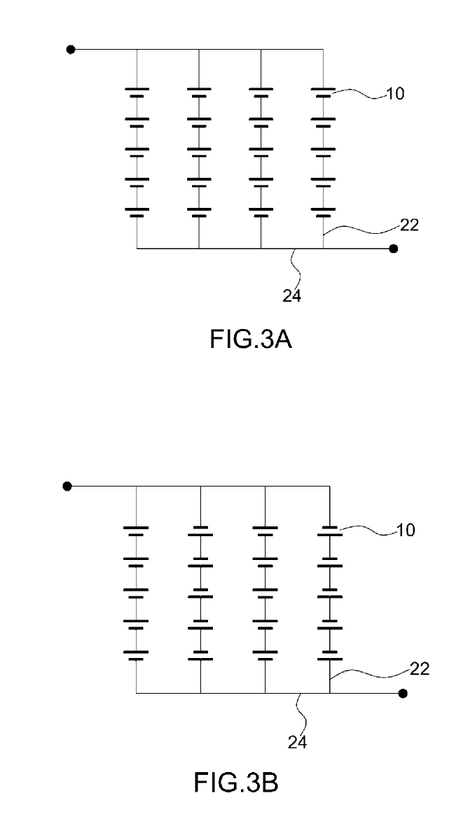

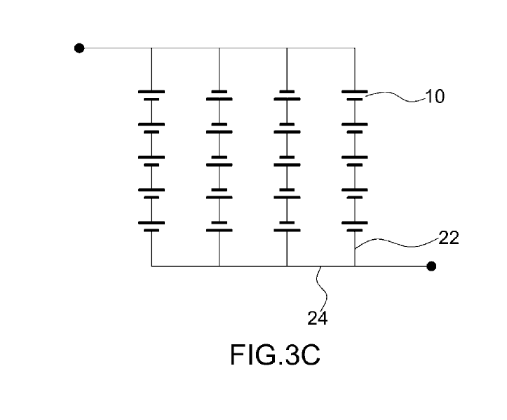

For this, as shown in FIGS. 3A through 3C, in a plurality of dye-sensitized solar cell unit modules 10 connected to each other in a matrix array for a roof panel 20, the dye-sensitized solar cell unit modules in the longitudinal direction may be connected to each other in series lines 22, and the series lines 22 may be connected to each other in a parallel line 24. Thus, the plurality of dye-sensitized solar cell unit modules 10 having the matrix array may be connected in series/parallel to each other.

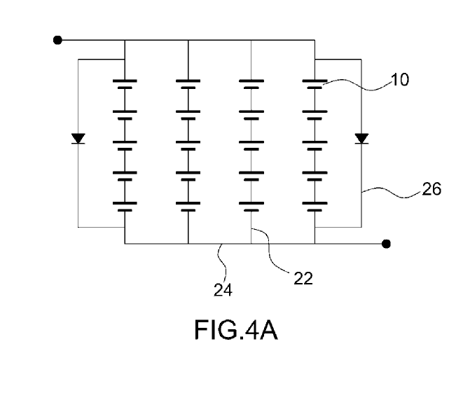

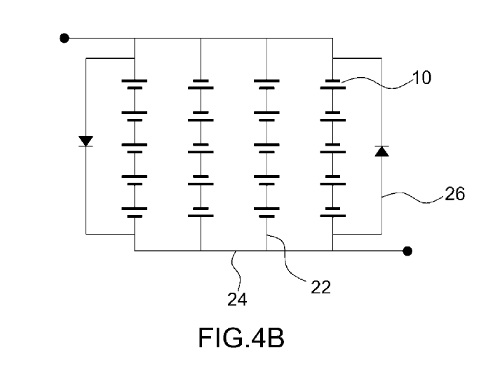

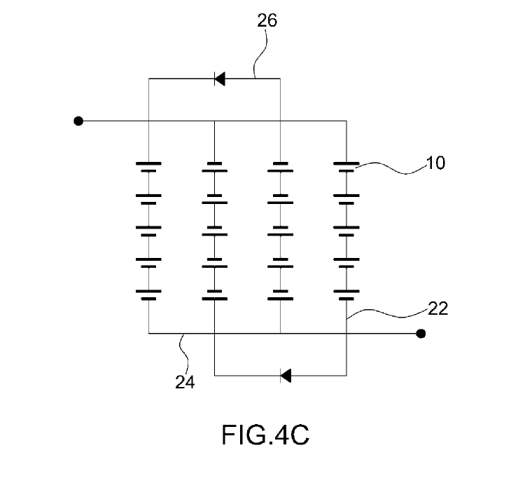

In this case, as shown in FIGS. 4A through 4C, two or more series lines 22 may be connected in parallel by a bypass line 26, respectively. Thus, even though a specific one of the plurality of dye-sensitized solar cell unit modules 10 is damaged during the operation of the roof panel, the output, current, and voltage can be steadily obtained from a normal dye-sensitized solar cell unit module via the bypass line 26. Here, the plurality of dye-sensitized solar cell unit modules constituting the roof panel may be conductively joined to each other, a detailed description of which will be described as follows.

For the configuration of the roof panel according to the exemplary embodiment of the present invention, when each electrode of the plurality of dye-sensitized solar cell unit modules having the matrix array are joined to each other, the plurality of dye-sensitized solar cell unit modules may be joined to each other across a wire connection structure.

Preferably, the wire connection structure may be formed of a thin soft wire manufactured using one material selected from the group consisting of copper, gold, silver, aluminum, and alloy thereof. Accordingly, as shown in FIG. 6, conductive paste (not shown, for example, silver paste and carbon paste) may be thinly coated on each electrode 11 of the plurality of dye-sensitized solar cell unit module 10, and then a soft wire 30 may be stacked therebetween to allow each electrode 10 to be conductively joined to each other.

Preferably, when the soft wire 30 is bonded in advance to each electrode 11 of the plurality of dye-sensitized solar cell unit modules 10, a consumed amount of conductive paste can be conserved, and human error such as further coating of conductive paste can be prevented. In this case, a typical wire bonding method in which the wire may be melted by high temperature heat to bond each electrode may be used to fix the soft wire to the electrode in advance.

Also, as shown in FIG. 6, when the soft wire 30 is disposed and bonded between the electrodes 11 of the dye-sensitized solar cell unit modules, the soft wire 30 may be deformed into a flat shape by a pressurized bonding strength. As a result, the thickness of the roof panel may slightly increase to no more than about 0.1 mm due to the wire deformed into the flat shape, and there is no limitation in applying the dye-sensitized solar cell unit modules 10 joined to each other to the roof panel.

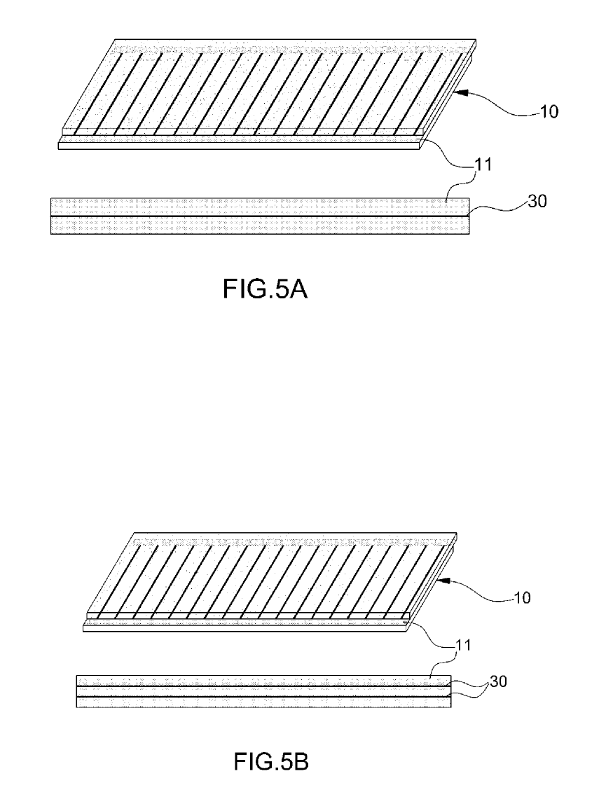

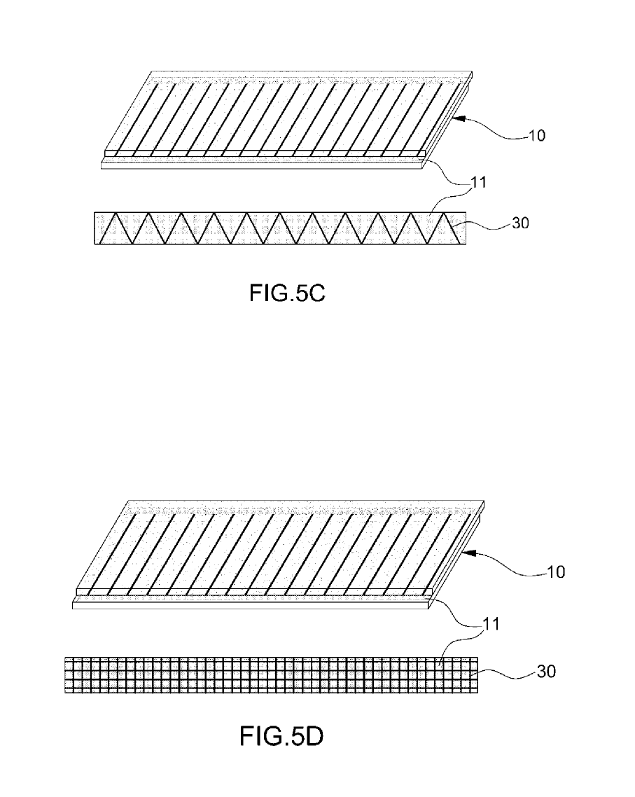

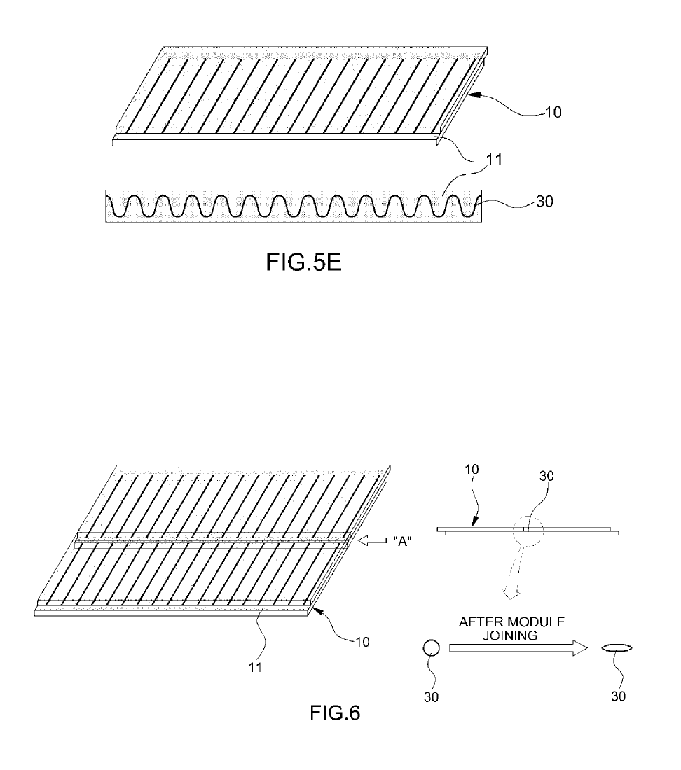

On the other hand, as shown in FIGS. 5A through 5E, when the soft wire 30 is applied to the electrode 11 of the plurality of dye-sensitized solar cell unit modules 10 constituting the dye-sensitized solar cell roof panel according to the exemplary embodiment of the present invention, one of a single straight line, a dual straight line, a zigzag line, a mesh, and a wave line can be applied in consideration of the length, width, and area of the electrode.

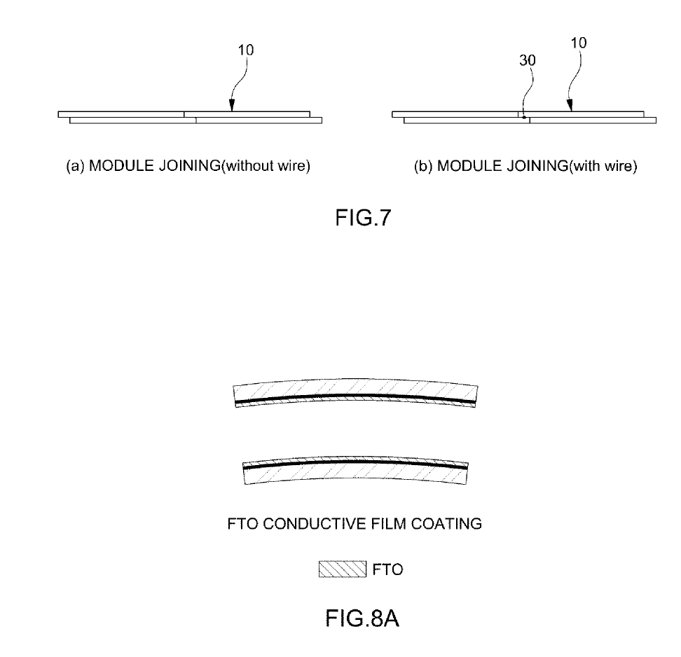

FIG. 7 is a cross-sectional view illustrating a comparison between dye-sensitized solar cell unit modules joined with a soft wire and dye-sensitized solar cell unit modules joined without a soft wire. A photocurrent and a fill factor of the dye-sensitized solar cell unit modules joined with a soft wire and the dye-sensitized solar cell unit modules joined without a soft wire were measured to increase from about 0.5 A to about 2.0 A and from about 24% to about 49%, respectively. Thus, it can be seen that the operation efficiency for the power generation both increases compared when the soft wire is not applied. This is because the resistance reduction effect is exerted at the bonding part between electrodes due to the introduction of the soft wire.

The present invention has the following advantages.

According to exemplary embodiments of the present invention, a resistance generated within an electrode contact part can be reduced by applying a wire connection structure, i.e., a soft wire to the electrode part where dye-sensitized solar cell unit modules are joined when configuring a roof panel by joining a plurality of dye-sensitized solar cell unit modules. Thus, when the soft wire is applied to the electrode part of each dye-sensitized solar cell unit module, since the conductivity of the metal wire is excellent upon bonding of the unit modules, the electrode contact between two modules can be improved. Also, due to the resistance reduction effect at the bonding part between electrodes, the power generation efficiency of the dye-sensitized solar cell unit module can be improved.

Also, target output, current, and voltage values can be obtained by connecting dye-sensitized solar cell unit modules in series-parallel. Furthermore, even when any of dye-sensitized solar cell unit modules is damaged during the operation of the roof, desired output, current, and voltage values can be obtained from the other normal unit modules through a bypass line.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A roof panel comprising a dye-sensitized solar cell, including a plurality of dye-sensitized solar cell unit modules having a matrix array, electrodes of which are disposed and joined to each other across a wire connection structure,
wherein the plurality of dye-sensitized solar cell unit modules are connected in series and parallel to each other.

2. The roof panel of claim 1, wherein among the plurality of dye-sensitized solar cell unit modules having the matrix array, dye-sensitized solar cell unit modules in a longitudinal direction are connected in series lines, and the series lines are connected in a parallel line to connect the plurality of dye-sensitized solar cell unit modules in the series and parallel to each other.

3. The roof panel of claim 2, wherein two or more series lines selected from the series lines are connected in parallel by a bypass line.

4. The roof panel of claim 1, wherein the wire connection structure is formed of a soft wire manufactured using one material selected from a group consisting of copper, gold, silver, aluminum, and alloy thereof.

5. The roof panel of claim 1, wherein the plurality of dye-sensitized solar cell unit modules comprise electrodes coated with conductive paste and a soft wire stacked therebetween to join the electrodes.

6. The roof panel of claim 1, wherein the plurality of dye-sensitized solar cell unit modules comprise a soft wire directly bonded to each of the electrodes.

7. The roof panel of claim 5, wherein the conductive paste includes silver paste or carbon paste.

8. The roof panel of claim 1, wherein the wire connection structure comprises a soft wire provided in a single straight line, a dual straight line, a zigzag line, a mesh, or a wave line

9. The roof panel of claim 1, wherein the wire connection structure comprises a soft wire deformed into a flat shape by a pressurized bonding strength when being disposed and bonded between the electrodes of the dye-sensitized solar cell unit modules.

10. The roof panel of claim 1, wherein the roof panel is installed in a hybrid vehicle.

11. The roof panel of claim 1, wherein the roof panel is installed in an electric vehicle.

12. The roof panel of claim 1, wherein the roof panel is installed in a gasoline vehicle.

13. The roof panel of claim 1, wherein the roof panel is installed in a fuel cell vehicle.
